(19) United States
(12) Patent Application Publication
(10) Pub. No.: US 2021/0362657 A1
(43) Pub. Date: Nov. 25, 2021

(54) COLLAPSIBLE WET UMBRELLA HOLDER CONE

(71) Applicant: Yoseif G. Aradom, Washington, DC (US)

(72) Inventor: Yoseif G. Aradom, Washington, DC (US)

(21) Appl. No.: 17/325,163

(22) Filed: May 19, 2021

Related U.S. Application Data
(60) Provisional application No. 63/026,903, filed on May 19, 2020.

(51) Int. Cl. B60R 7/12; A45B 25/28

(52) U.S. Cl. CPC B60R 7/12; A45B 25/28

(57) ABSTRACT

A collapsible umbrella holder configured to capture and dispose water from an umbrella stored therein includes a conical shaped holder, the holder having an open first end to receive an umbrella and an opposing second end; and a removable compartment configured to capture water from the umbrella, the removable compartment detachably coupled to the second end of the conical shaped holder.

### BACKGROUND OF THE INVENTION

### 1. Field of the Invention

The present general inventive concept relates to umbrella cases that have been developed to store wet umbrellas, and more particularly, to collapsible umbrella cases configured to be mounted within a vehicle.

### 2. Description of Related Art

There have been previous umbrella cases that have been developed to store wet umbrellas. However, these cases fail to be collapsible and are not designed to be mounted inside vehicles to protect the interior carpet from damage. Further, the conventional umbrella cases are not designed for use from outside of the vehicle.

Therefore, what is desired is a collapsible cone-shaped umbrella holder that is installed inside a vehicle to protect the interior by storing water within a removable compartment.

### SUMMARY OF THE INVENTION

Certain of the foregoing and related aspects are readily attained according to the present general inventive concept by providing a collapsible umbrella holder configured to capture and dispose water from an umbrella stored therein including a conical shaped holder, the holder having an open first end to receive an umbrella and an opposing second end, and a removable compartment configured to capture water from the umbrella, the removable compartment detachably coupled to the second end of the conical shaped holder.

The collapsible umbrella holder may further include an attachment member coupled to a pivot point disposed at the first end of the holder.

The attachment member may further include a through hole configured to attach an interior of a vehicle.

The holder may be substantially hollow and may be comprised of waterproof material.

An inner surface of the holder may be formed with a wicking material configured to wick moisture away from an umbrella disposed therein.

The holder may further include an absorbent material disposed within the holder configured to retain moisture therein.

The first end of the holder may be formed with an inclined surface configured to receive an umbrella.

In contrast with conventional methods disclosed by the prior art, the present general inventive concept utilizes a collapsible conically shaped holder that is designed to mount within a vehicle and pivot when a user inserts and/or removes an umbrella. As such, the user may easily insert and remove the umbrella, while remaining outside of the vehicle. The present inventive concept further provides a detachable water storage compartment at the bottom of the collapsible umbrella holder to easily pour out water captured from umbrellas.

In addition, the device and method according to the present inventive concept provides significantly improved protection of the interior of a vehicle from water and moisture from a user's wet umbrellas.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view a collapsible umbrella holder according to an embodiment of the present inventive concept;

FIG. 2 illustrates a front view of the collapsible umbrella holder illustrated in FIG. 1, showing a surface at angle A1;

FIG. 3 is a right-side view of the collapsible umbrella holder illustrated in FIG. 1;

FIG. 4 is a partially assembled perspective view of the collapsible umbrella holder illustrated in FIG. 1;

FIG. 5 is a top perspective view of the collapsible umbrella holder illustrated in FIG. 1, in a collapsed state;

FIG. 6 is a side view of the collapsible umbrella holder illustrated in FIG. 5;

FIG. 7 is a back view of the collapsible umbrella holder illustrated in FIG. 5;

FIG. 8 is a top view of the collapsible umbrella holder illustrated in FIG. 5;

FIG. 9 is a bottom view of the collapsible umbrella holder illustrated in FIG. 5;

FIG. 10 is a front perspective view the collapsible umbrella holder according to another embodiment of the present inventive concept;

FIG. 11 is a side view of the collapsible umbrella holder illustrated in FIG. 10; and

FIG. 12A through 12H illustrates a method of inserting a wet umbrella into the collapsible umbrella holder of FIG. 10.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below to explain the present general inventive concept by referring to the figures.

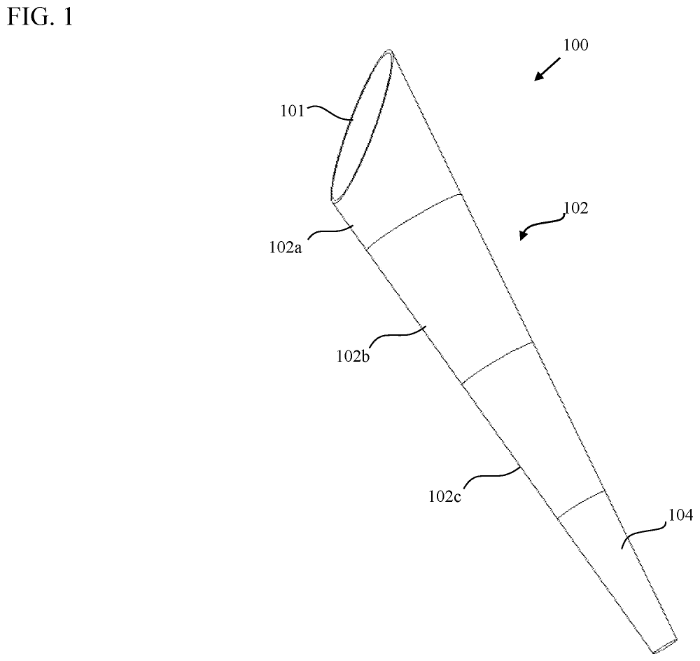

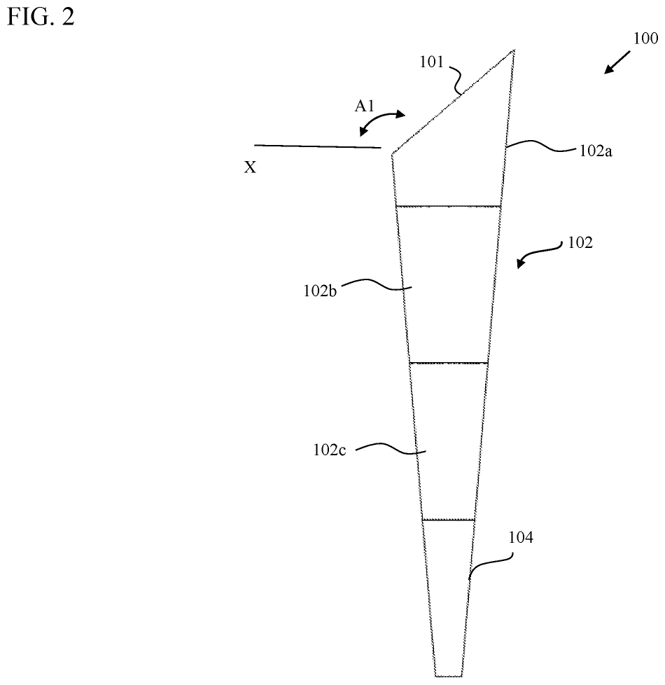

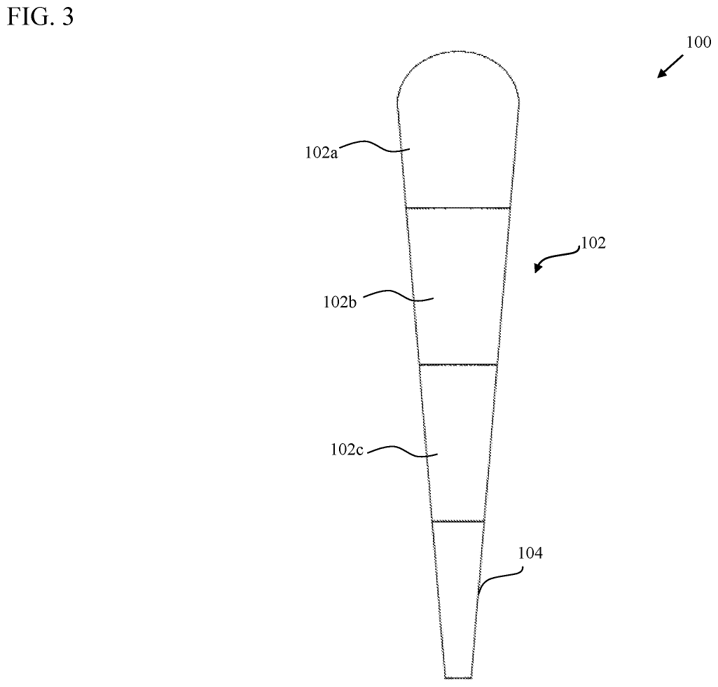

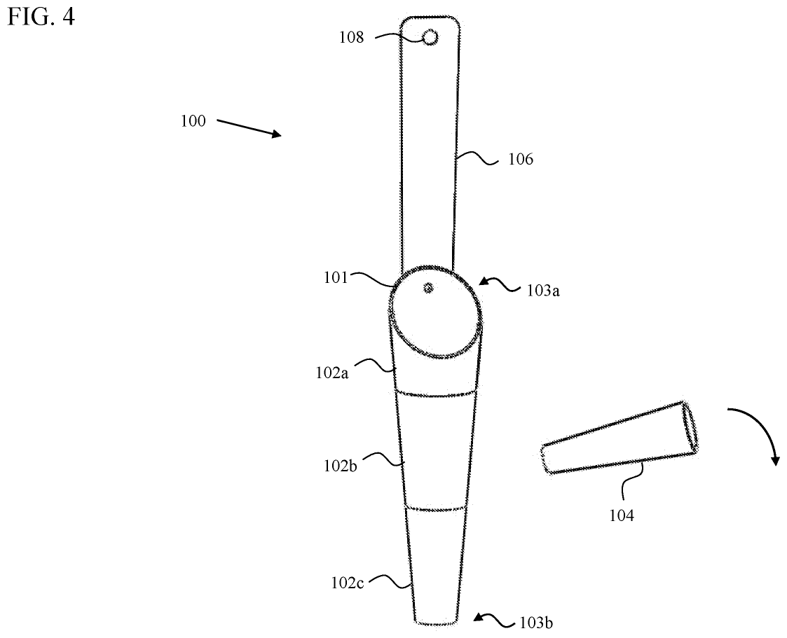

FIG. 1 is a front perspective view a collapsible umbrella holder 100 according to an embodiment of the present inventive concept, FIG. 2 illustrates a front view of the collapsible umbrella holder 100 illustrated in FIG. 1 showing a surface 101 inclined at an angle A1, and FIG. 3 is a right-side view of the collapsible umbrella holder 100 illustrated in FIG. 1. FIG. 4 is a partially assembled perspective view of the collapsible umbrella holder 100 illustrated in FIG. 1. In the present embodiment, the surface 101 is inclined at an angle A1 from about 15 degrees to about 75 degrees. However, the present general inventive concept is not limited thereto.

Referring to FIGS. 1 through 3, the collapsible umbrella holder 100, designated generally as 100, is illustrated. In the present embodiment, the collapsible umbrella holder 100 includes a holder 102 having a plurality of collapsible portions 102a,102b,102c, a removably coupled water storage compartment 104, and a vehicle attachment member 106 (see FIG. 4).

In the present embodiment, the collapsible umbrella holder 100 is configured to store and dispose water captured from an umbrella 10 stored therein. The holder 102 is substantially hollow and includes a first end 103a and an opposing second end 103b.

Referring to FIG. 4, the first end 103a is open in order to receive an umbrella 10 into the holder 102 and the second end 103b is configured to be detachably coupled to the water storage compartment 104.

In the present embodiment, the holder 102 is formed in conical or frustoconical shape to force water and/or moistures from within the holder 102 to flow into the water storage compartment 104. However, the present general inventive concept is not limited thereto.

That is, in alternative embodiments, the collapsible umbrella holder 100 is designed as a collapsible cone-shaped design that can be adjusted to fit different sizes of umbrellas 10 and includes a water storage compartment 104 that is removable to pour out collected water.

In the present embodiment, the holder 102 includes a plurality of collapsible portions 102a,102b,102c which are collapsible onto each other and the water storage compartment 104 for ease of storage and transport.

Referring to FIG. 4, the removable compartment configured to capture water from the umbrella, the removable compartment detachably coupled to the second end of the conical shaped holder.

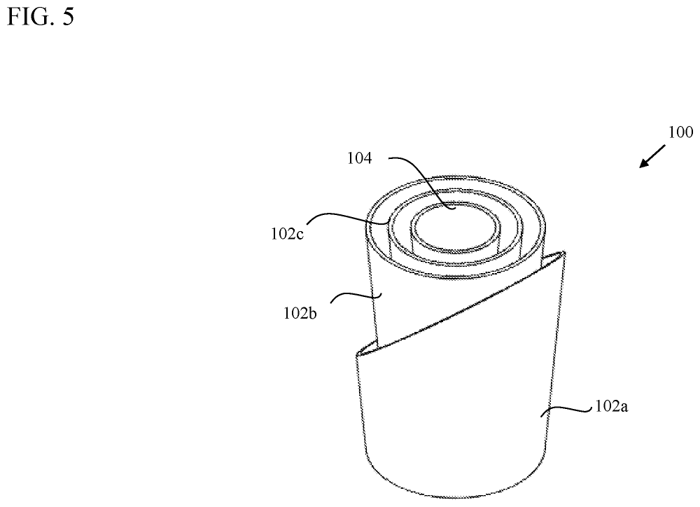

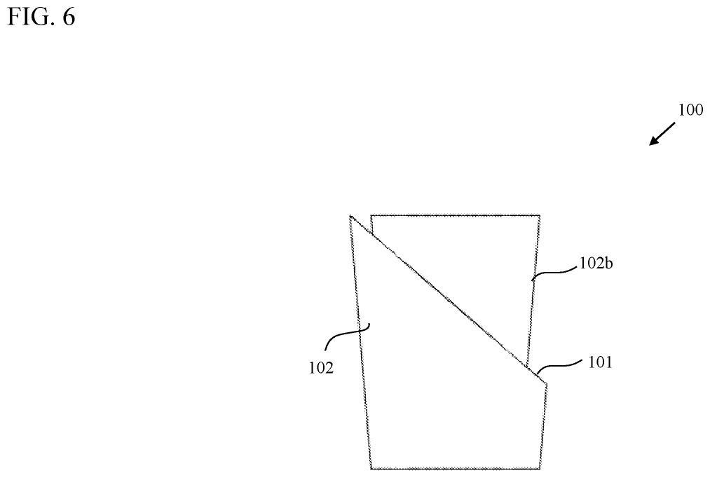

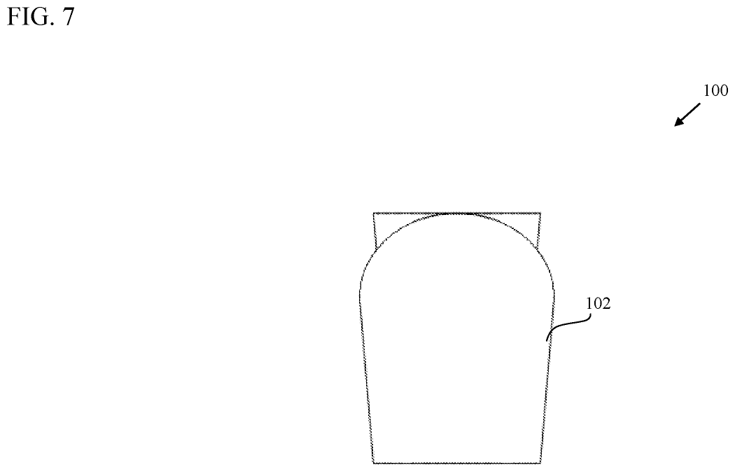

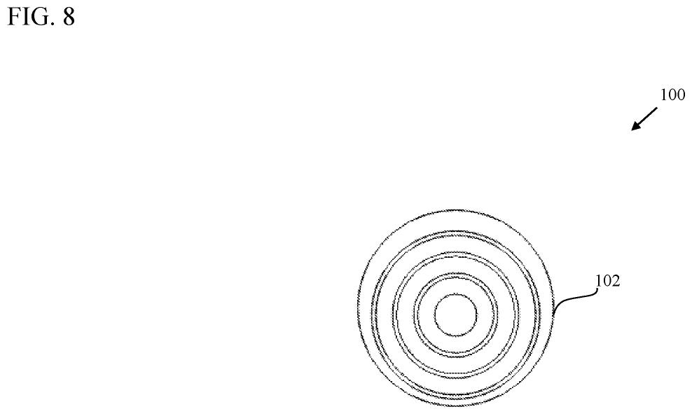

FIG. 5 is a top perspective view of the collapsible umbrella holder illustrated in FIG. 1, in a collapsed state, FIG. 6 is a side view of the collapsible umbrella holder illustrated in FIG. 5, and FIG. 7 is a back view of the collapsible umbrella holder illustrated in FIG. 5. FIG. 8 is a top view of the collapsible umbrella holder illustrated in FIG. 5.

In the present embodiment, the collapsible umbrella holder 100 is designed as a conical or cone-shaped umbrella holder 102 that is installed within an interior of a vehicle to protect the interior from moisture and damage. However, the present general inventive concept is not limited thereto.

That is, in alternative embodiments, the collapsible umbrella holder 100 may be formed in various shapes designed to collect water and moisture from an umbrella 10 disposed therein.

In the present embodiment, the removable water storage compartment 104 is attached to a bottom-most portion of the cone-shaped housing 102 and is used to collect water from wet umbrellas stored therein. The removable water storage compartment 104 is removed to empty the collected water.

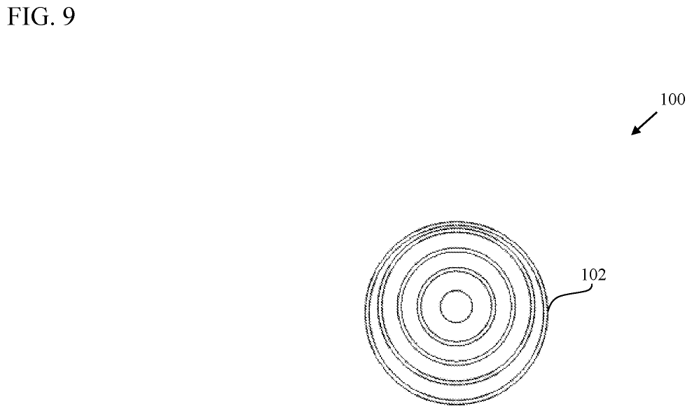

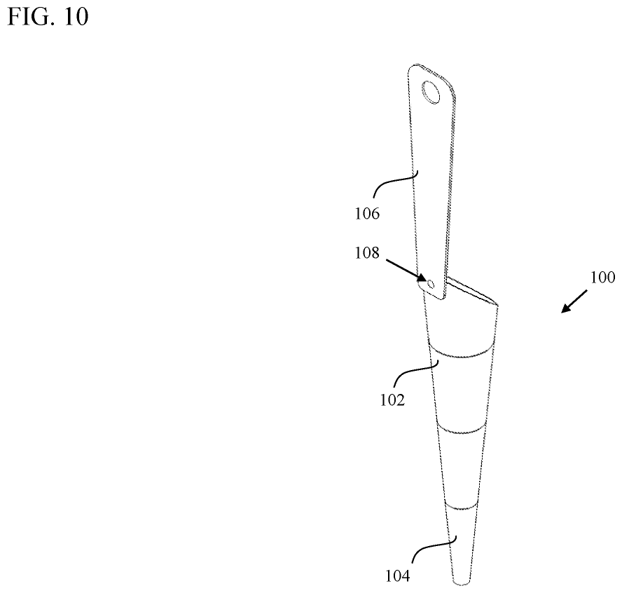

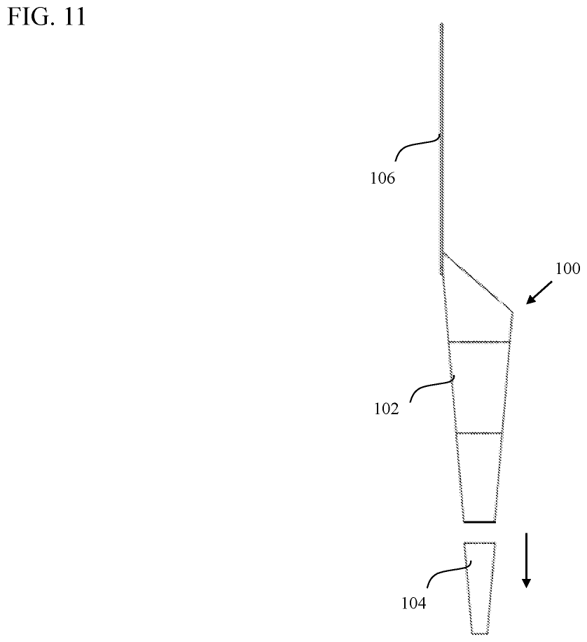

FIG. 9 is a bottom view of the collapsible umbrella holder illustrated in FIG. 5, FIG. 10 is a front perspective view the collapsible umbrella holder according to another embodiment of the present inventive concept, and FIG. 11 is a side view of the collapsible umbrella holder illustrated in FIG. 10.

That is, in alternate embodiments, the collapsible wet umbrella holder-cone 100 may further include a vehicle attachment member 106 to be detachably coupled to a head rest inside a vehicle. The vehicle attachment member 106 is designed to attached to the collapsible cone-shaped housing 102 by a single pivot point (or through hole) 108. The single pivot point 108 allows the collapsible wet umbrella holder cone 100 to pivot when a user installs a wet umbrella into the cone-shaped housing 102. However, the present general inventive concept is not limited thereto.

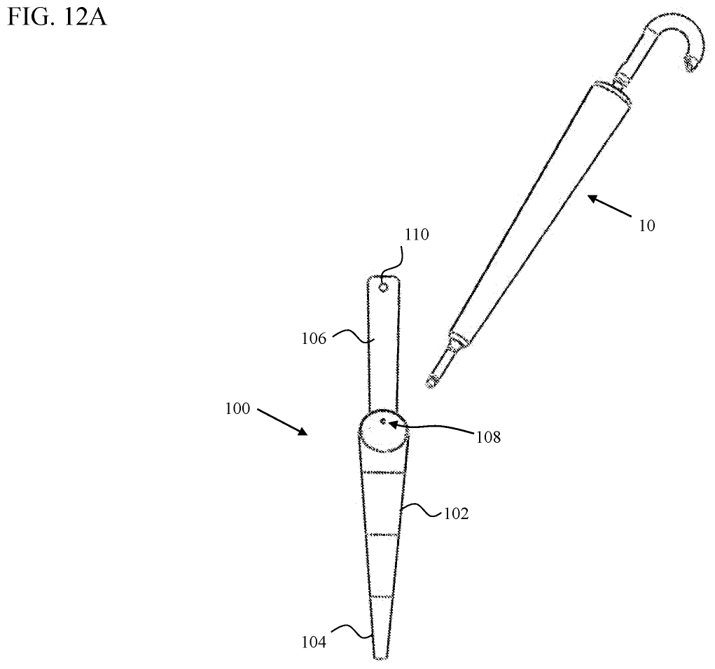

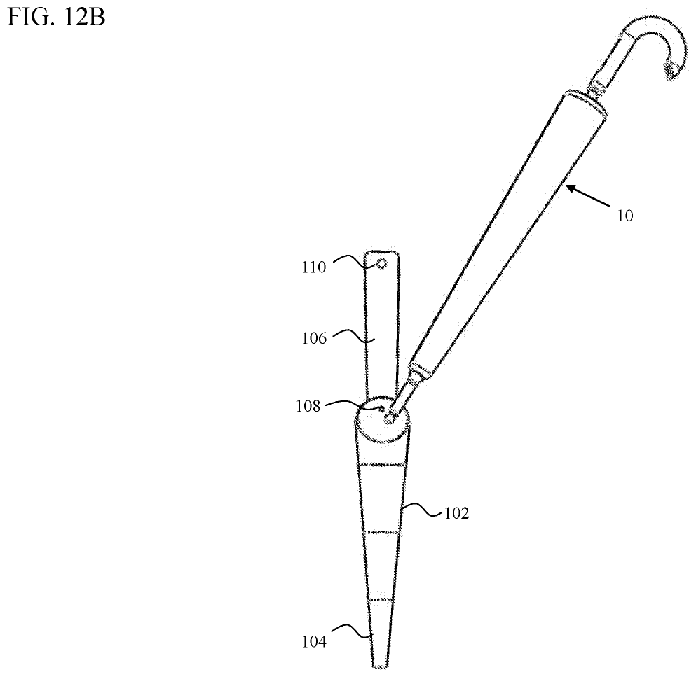

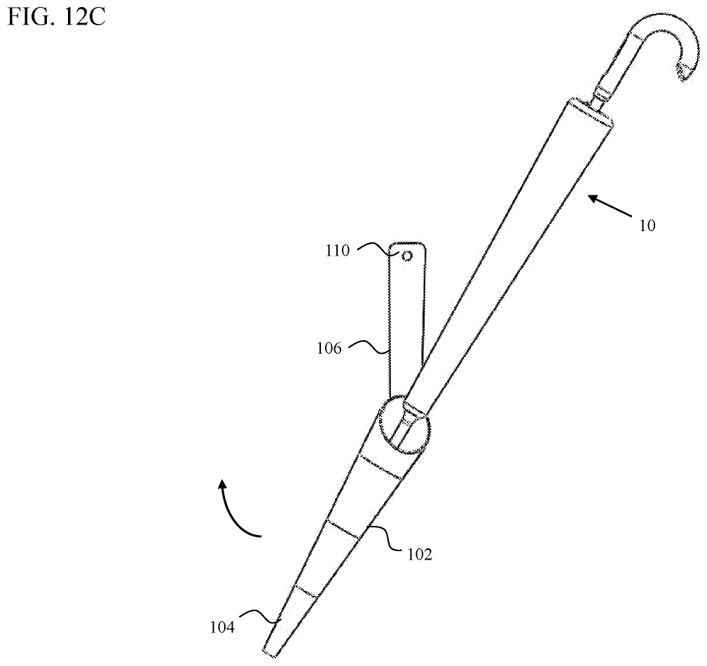

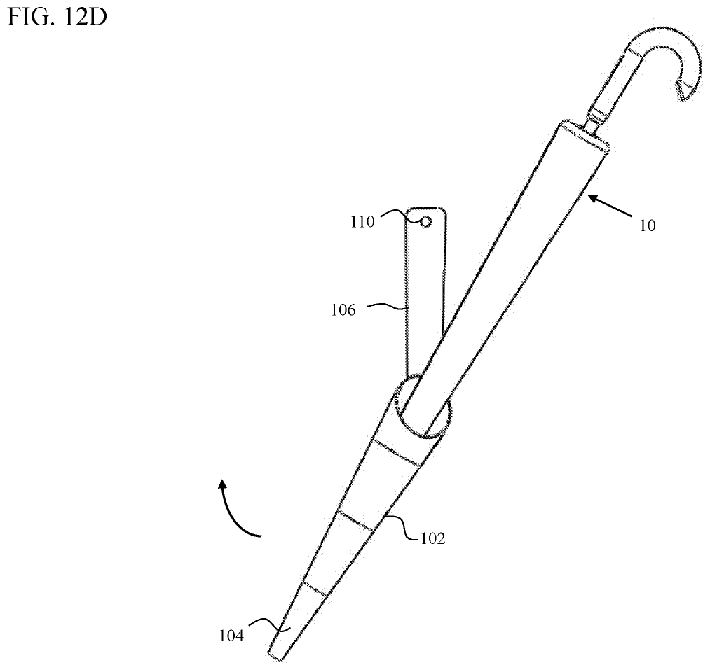

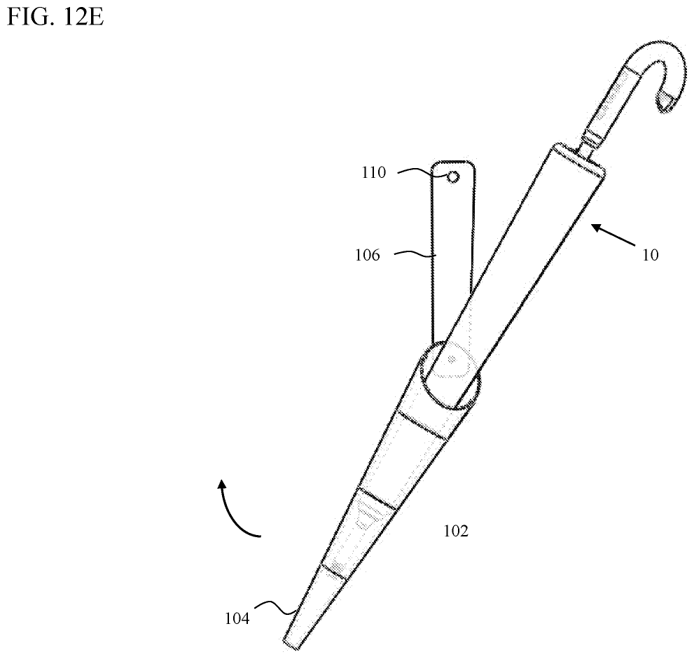

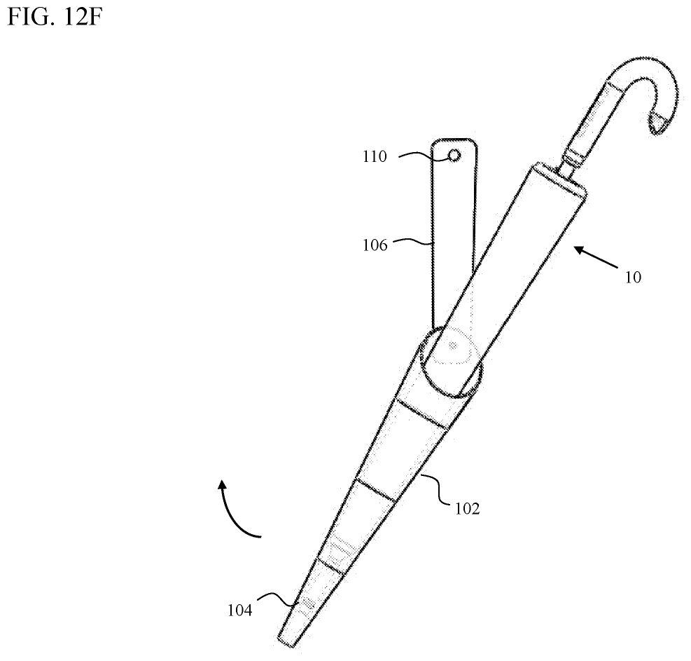

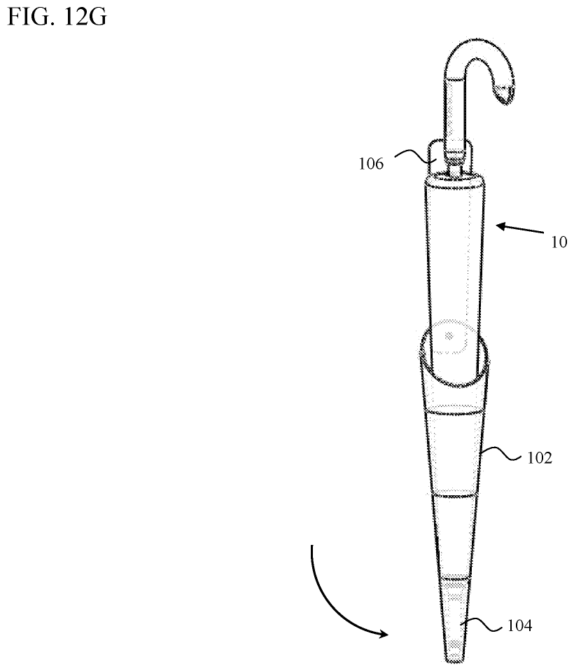

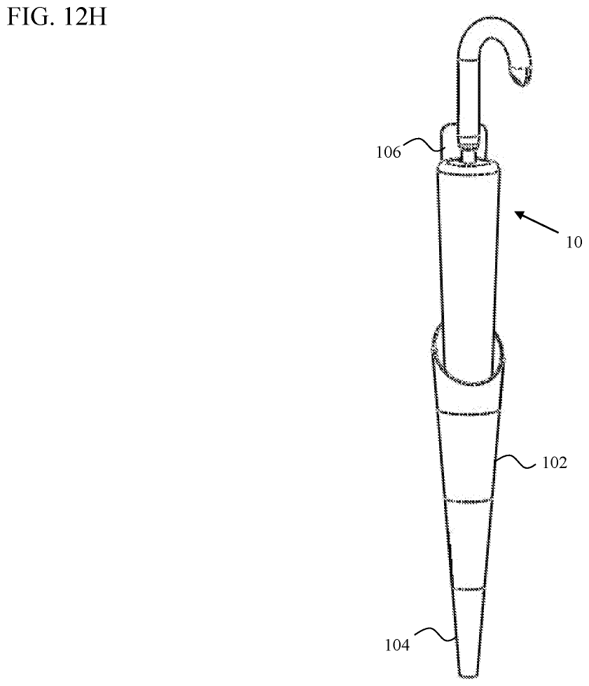

FIG. 12A through 12H illustrates a method of inserting a wet umbrella into the collapsible umbrella holder 100 of FIG. 10.

A collapsible umbrella holder 100 is mounted within an interior of a vehicle using the attachment hole 110 of the attachment member 106. As a user enters the vehicle, he or she may insert the umbrella 10 into the holder 102, while still remaining outside of the vehicle. The single pivot point 108 of the attachment member 106 allows the holder 102 to pivot or move which allows the user to easily insert the umbrella 10 into the holder 102.

Once the umbrella 10 is fully inserted into the holder 102, the holder 102 pivots back to being vertical which allows the water from the umbrella 10 to flow into the water storage compartment 104. The water storage compartment 104 may then be removed from the holder 102 to empty the collected water.

The collapsible cone-shaped wet umbrella holder according to present inventive concept is installed inside a vehicle to protect the interior by storing water within a removable compartment. The collapsible cone-shaped wet umbrella holder is collapsible, light weight and easy to carry. The sections of the collapsible cone-shaped wet umbrella holder may be detachable. The removable water storage compartment 104 is removed to dump out collected water from a wet umbrella. The vehicle attachment member 106 is designed to allow the collapsible wet umbrella holder-cone 100 to pivot around a through hole 108 to allow the user to easily insert and remove an umbrella into/from the housing 102, even when standing outside of the vehicle.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A collapsible umbrella holder configured to capture and dispose water from an umbrella stored therein, comprising:
a conical shaped holder, the holder having an open first end to receive an umbrella and an opposing second end;
a removable compartment configured to capture water from the umbrella, the removable compartment detachably coupled to the second end of the conical shaped holder.

2. The collapsible umbrella holder of claim 1, further comprising an attachment member coupled to a pivot point disposed at the first end of the holder.

3. The collapsible umbrella holder of claim 2, wherein the attachment member further comprises a through hole configured to attach an interior of a vehicle.

4. The collapsible umbrella holder of claim 3, wherein the holder is substantially hollow.

5. The collapsible umbrella holder of claim 3, wherein the holder is substantially hollow.

6. The collapsible umbrella holder of claim 5, wherein the holder is comprised of waterproof material.

7. The collapsible umbrella holder of claim 6, wherein an inner surface of the holder is formed with a wicking material configured to wick moisture away from an umbrella disposed therein.

8. The collapsible umbrella holder of claim 1, further comprising an absorbent material disposed within the holder configured to retain moisture therein.

9. The collapsible umbrella holder of claim 1, wherein the first end of the holder is formed with an inclined surface configured to receive an umbrella.
